(19) United States
(12) Patent Application Publication
(10) Pub. No.: US 2018/0265012 A1
(43) Pub. Date: Sep. 20, 2018

(54) VEHICLE DOCUMENTATION ORGANIZERS/VISORS & SYSTEMS

(71) Applicants: Curtis L. Hutson, New Castle, DE (US); Garth Eric Warner, SR., Wilmington, DE (US)

(72) Inventors: Curtis L. Hutson, New Castle, DE (US); Garth Eric Warner, SR., Wilmington, DE (US)

(21) Appl. No.: 15/462,799

(22) Filed: Mar. 17, 2017

(51) Int. Cl. B60R 7/05; G06K 19/06

(52) U.S. Cl. CPC B60R 7/05; B60R 2011/0035; G06K 19/06037

(57) ABSTRACT

Disclosed herein are vehicle documentation organizers/visors and systems. In one embodiment, a vehicle documentation system includes an instruction card, having indicia disposed thereon; a vehicle documentation organizer/visor, including one or more compartments for insertion of documentation; and a computer-readable code, disposed on one of the instruction card or the a vehicle documentation organizer/visor, the computer-readable code including a portion attachable to a vehicle, with the computer-readable code being scannable and associated with a database. Information from the database may be contained in mobile application, having one or more user interfaces.

### CROSS-REFERENCE TO RELATED APPLICATIONS

This application claims priority to U.S. Application Nos. 62/309,934, filed Mar. 17, 2016 and 62/432,053, filed Dec. 9, 2016. The entirety of each aforementioned application is incorporated herein by reference.

### BACKGROUND

The field of the invention relates to vehicle documentation organizers/visors and systems, particularly organizers/visors and systems that include components, integral or connectable to automobile components, and preferably automobile components located on, near, or close to the driver's side of a vehicle. The overall mission of each invention disclosed herein is to promote driver safety and organization of essential documentation when a person is behind the wheel of the automobile. In so doing, the goals of the inventors firmly stand in support of the Community, Police, Paramedics, and Fire Fighters and strive to work in harmony to keeps all vehicle passengers safe and alive.

It is common knowledge in the United States and in many places abroad that traffic stops cause angst for both police officers who stop a vehicle as well as the drivers and passengers in a vehicle. Traffic stops occur when a driver is detained by police to either (1) investigate whether an occupant in the vehicle has committed a crime or is about to commit a crime, (2) issue a citation for a traffic offense, or (3) make an arrest. From the police officer's perspective, a traffic stop is one of the most dangerous tasks an officer must perform because the officer never knows how the driver may respond. Accordingly, during traffic stops, officers are trained to remain on guard at all times.

During a traffic stop, a critical encounter occurs when the officer asks the driver for documentation and the driver looks for the requested documentation. In the United States, such documentation typically includes a driver's license, an insurance card, and registration for the vehicle. The driver may keep these documents in various places inside the car. Often, for example, vehicle registration is kept in the glove compartment, while a driver's license is kept inside of a wallet. During this critical encounter, a police officer is trained to remain cautious of the driver's actions. In contrast, occupants of the vehicle may or may not know that they should be conscious of their movements during this critical encounter, and not move in a way that could be perceived as threatening to the police officer.

In addition to the documentation required for traffic stops, a need also exists for various types of personnel to have access to documentation contained in a vehicle. For example, after a collision, emergency personnel may need to find documentation for the driver vehicle. Other types of personnel who may need access to documentation include, but are not limited to, fire fighters, medical personnel (e.g. paramedics), and travel/vehicles services (e.g. AAA).

Accordingly, there is a need for vehicle documentation organizers/visors and systems that keep documentation typically requested by a police officer in an easily accessible location in plain view of the police officer. The invention, as disclosed and claimed, fulfills this need and provides related advantages as further described herein.

### BRIEF SUMMARY

Described herein are vehicle documentation organizers/visors and systems. One embodiment of the invention is configured as a vehicle documentation system. In this embodiment, the vehicle documentation system includes an instruction card, having indicia disposed thereon; a vehicle documentation organizer/visor, including one or more compartments for insertion of documentation; and a computer-readable code, disposed on one of the instruction card or the a vehicle documentation organizer/visor, the computer-readable code including a portion attachable to a vehicle, with the computer-readable code being scannable and associated with a database. Information from the database may be contained in mobile application, having one or more user interfaces. Additional embodiments of the invention are described in more detail below.

### DESCRIPTION OF THE DRAWINGS

The accompanying drawings are included to provide a further understanding of the present disclosure and are incorporated in and constitute a part of this specification, illustrate embodiments of the present disclosure, and together with the description serve to explain the principles of the present disclosure. In the drawings:

FIG. 1 schematically shows the traffic stop situation in 2016, with respect to police and civilians who are vehicle occupants;

FIG. 2 shows a first exemplary embodiment of the invention mounted to a roof of a vehicle on the driver's side of the vehicle;

FIG. 3 shows a second exemplary embodiment of the invention mounted to a vehicle sun visor on the driver's side of the vehicle;

FIGS. 4 and 5 show various views of exemplary embodiments of the invention;

FIG. 6 shows an exemplary clip that may be included in the systems disclosed herein;

FIG. 7 shows additional examples of the systems disclosed herein;

FIG. 8 is a schematic representation of elements that may be included in one embodiment of a vehicle documentation organizer system;

FIG. 9 shows an enlarged view of an exemplary instruction card that may be included in one or more embodiments of the vehicle documentation organizer systems disclosed herein; and

FIG. 10 shows a flowchart of an exemplary vehicle documentation organizer system, which is configured to include a mobile device/computer application.

### DETAILED DESCRIPTION

The following description should be read with reference to the drawings, wherein like reference numerals indicate like elements throughout the several views. The drawings, which are not necessarily to scale, are not intended to limit the scope of the claimed invention. The detailed description and drawings illustrate exemplary embodiments of the invention, as described and claimed. Those skilled in the art will recognize that the various elements described and/or shown may be arranged in various combinations and configurations without departing from the scope of the disclosure.

All numerical values herein are assumed to be modified by the term “about.” The disclosure of numerical ranges by endpoints includes all numbers subsumed within that range (e.g., 1 to 5 includes 1, 1.5, 2, 2.75, 3, 3.80, 4, and 5).

As used in this specification and the appended claims, the singular indefinite articles “a”, “an,” and the definite article “the” should be considered to include or otherwise cover both single and plural referents unless the content clearly dictates otherwise. In other words, these articles are applicable to one or more referents. As used in this specification and the appended claims, the term “or” is generally employed to include or otherwise cover “and/or” unless the content clearly dictates otherwise.

References in the specification to “an embodiment,” “embodiments,” “such embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, any particular feature, structure, or characteristic described in connection with a particular embodiment is intended to be applied, incorporated or substituted into other embodiments, whether or not explicitly described, unless clearly stated to the contrary.

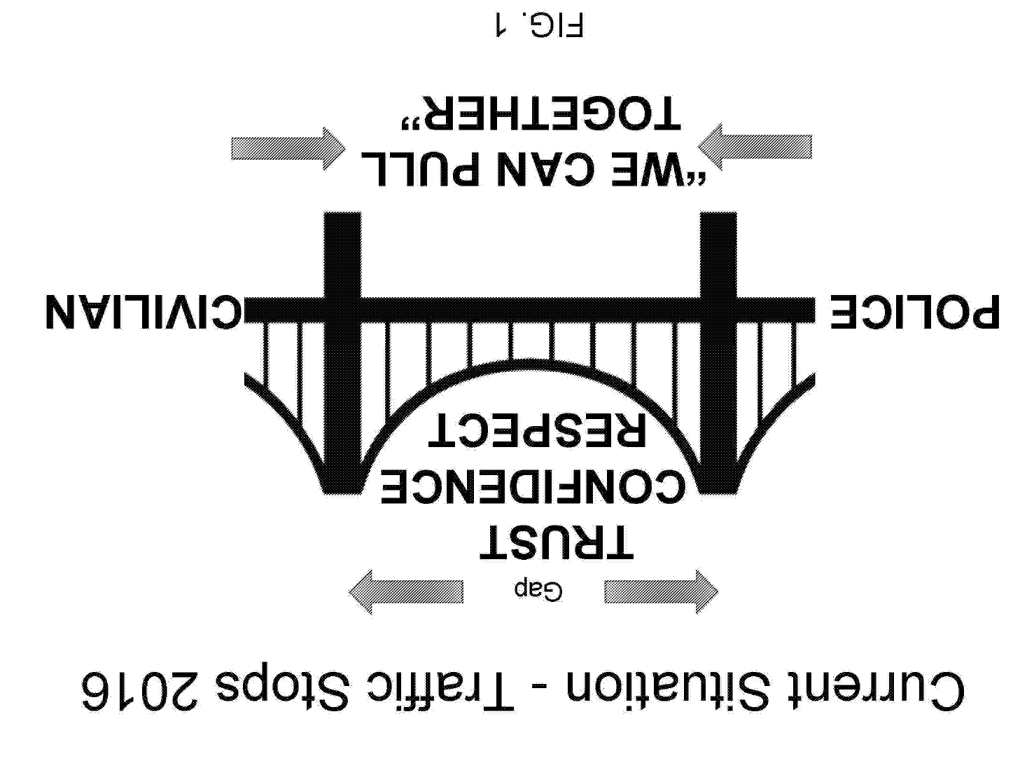

Turning in detail to the drawings, FIG. 1 schematically shows the traffic stop situation in 2016, with respect to police and civilians who are vehicle occupants. The schematic is intended to illustrate that during the critical encounter, which occurs while a driver or vehicle occupants (civilians) searches for stop documentation, bridges a theoretical gap between officers and civilians. Stated differently, by providing a traffic stop documentation organizer/visor, police and civilians can come together to have more trust, confidence, and respect toward one another, regarding the actions taken during a traffic stop.

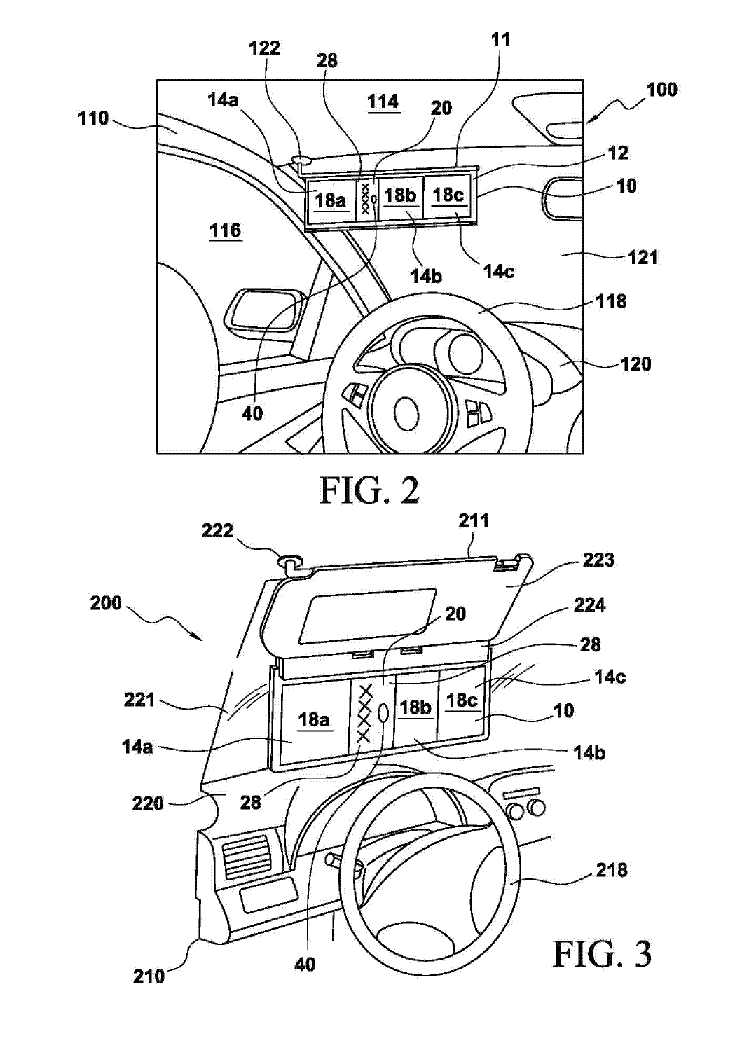

FIG. 2 partially shows the interior of driver's side of a vehicle 100, with the driver's side being on the left of the vehicle. The vehicle 100 includes a vehicle body 110, having an interior 112, with a ceiling 114, driver's side window 116, a steering wheel 118, a dashboard 120, and a windshield 121, among other elements which will not be described herein. This vehicle 200 also includes all such components which are required for vehicles manufactured in accordance with the Federal Motor Vehicle Safety Standards (FMVSS) and Regulations to which manufacturers of motor vehicle and equipment items must conform and certify compliance in the United States of America as well as other compliance agencies outside of the United States.

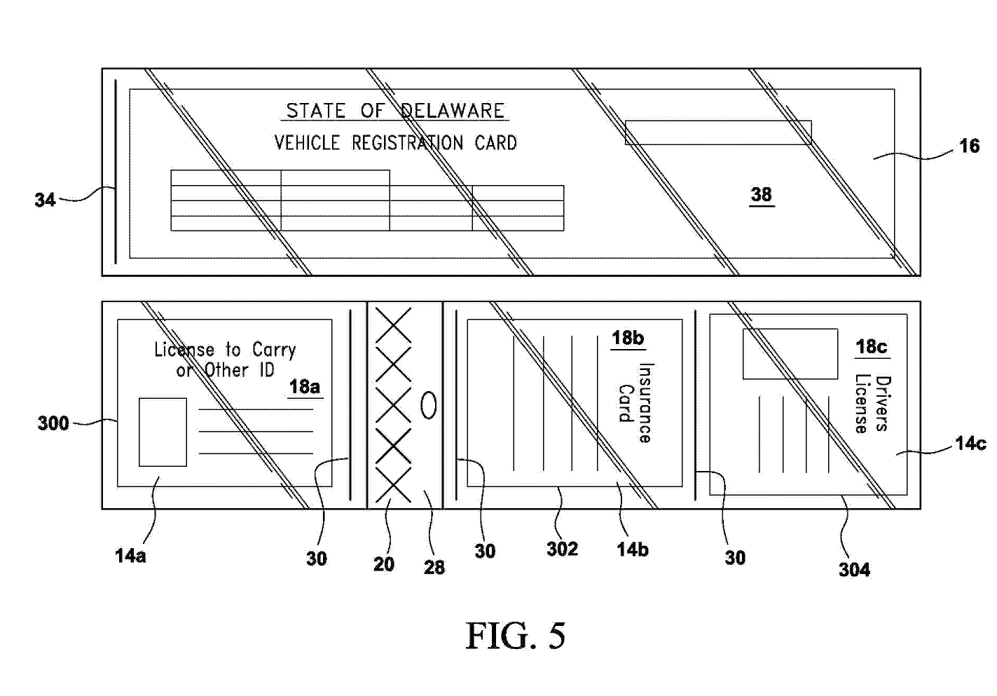

Mounted to the ceiling 114 is a visor mount 122, which is coupled to a traffic stop documentation organizer/visor 10. Coupled to the visor mount 122 and the organizer/visor 10 is an elongated mounting bar 11. With respect to the embodiments described herein, the organizer/visor 10 includes a plurality of layers. One exemplary embodiment includes a base layer 12 and layers 14a, 14b. 14c, 16 (shown in FIG. 5) connected to the base layer 12.

The base layer 12 preferably is manufactured from an opaque or partially opaque material. Preferred materials include, but are not limited to plastic materials such as vinyl, and particularly polyvinyl chloride (PVC) materials, leather, suede, leather-like materials. One such material is sold under the brand name ALCANTARA® and is manufactured and marketed by Alcantara SpA. The listing of such materials, however, should not be construed as limiting. Components of the organizers, visors, and systems disclosed herein may include any material suitable for the overall purpose as a documentation holder, visor, or system.

Layers 14a, 14b, 14c are coupled to the base layer 12 such that compartments 18a, 18b, 18c (shown in FIG. 5, referred to collectively as 18) are formed in the organizer/visor 10. Preferably between the compartments 18, an area 28 on the base layer 12 is left such that indicia 20 (e.g. a company logo) can be imprinted or embossed onto the organizer/visor 10. Although three (3) layers 14a, 14b, 14c are shown in the embodiments of the organizers/visor described, this number should not be construed as limiting.

FIG. 3 partially shows the interior of driver's side of another vehicle 200, with the driver's side being on the left of the vehicle. The vehicle 200 similarly includes a vehicle body 210, having an interior 212, with a ceiling 214, driver's side window (not shown), a steering wheel 218, a dashboard 220, and a windshield 221, among other elements which will not be described herein. This vehicle 200 similarly includes all such components which are required for vehicles manufactured in accordance FMVSS.

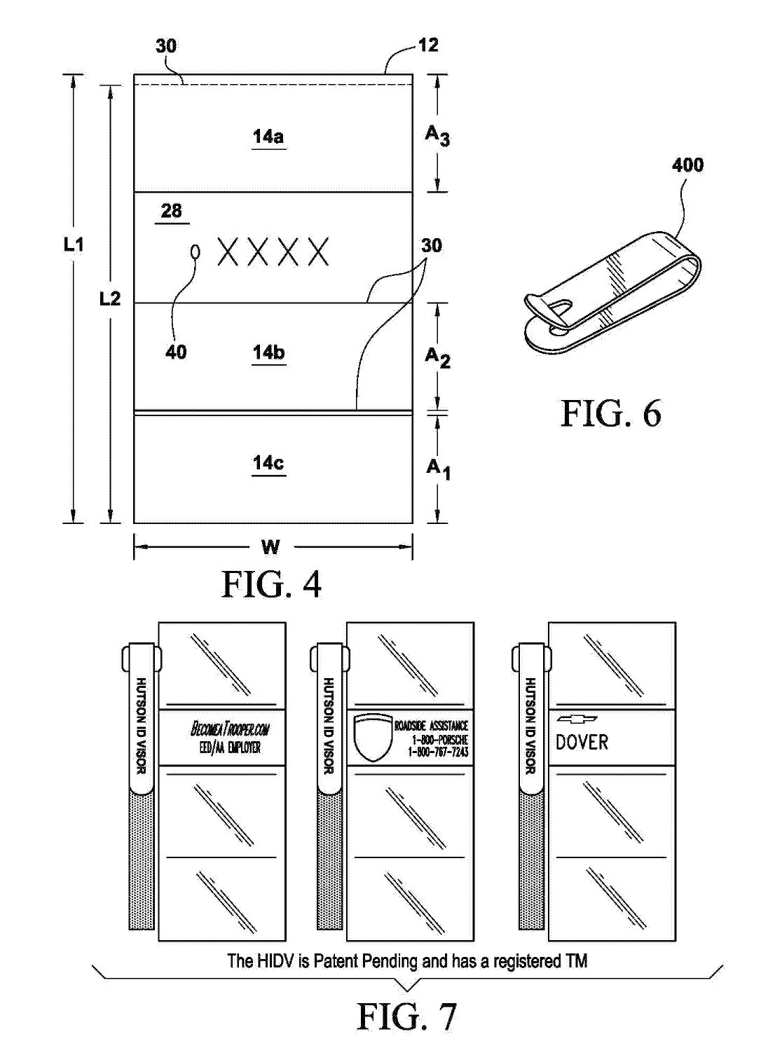

FIG. 4 shows a top view of an embodiment of the organizer/visor 10 with additional detail with respect to the approximate measurement of the organizer/visor 10. The base layer 12 of the organizer/visor 10 preferably has and overall length L1, being about nine (9) inches and an overall width W, being about four (4) inches. In this embodiment, three (3) layers 14a, 14b, 14c are shown with an area 28 positioned between layers 14a and 14b for indicia 20. Layers 14a, 14b, 14c and compartments 18a, 18b, 18c may be further defined with respect to dimensions A1, A2, and A3, as shown in FIG. 4, which may range from about two (2) inches to about three (3) inches. FIG. 4 also shows exemplary positioning of openings 30, which are preferably included in the organizer/visor 10.

FIGS. 5 and 7 show other exemplary embodiments of an organizer/visor 10, 510. FIG. 5 particularly shows additional detail with respect to the use of compartments 18a, 18b, 18c, and 38. Compartment 18a may be used to carry a second ID or a license to carry 300 (shown schematically with text), compartment 18b may be used to carry an insurance card 302, and compartment 18c may be used to carry a driver's license 304. The opposite compartment 16 may be used to carry a vehicle registration 306, which is inserted into opening 34.

FIG. 6 shows an exemplary clip 400 that may be included in the systems disclosed herein. The clip is preferably manufactured from a corrosion resistant material such as a plastic or a treated metal. The clip 400 show is a u-type clip fastener. These types of clips can be positioned against automobile components such that they snap and provide a clamping action for firm, vibration-free assembly. These fasteners typically require no holes, screws, welds, rivets, or other secondary fastening devices. The clips 400 may also be manufactured with barbs for additional retention.

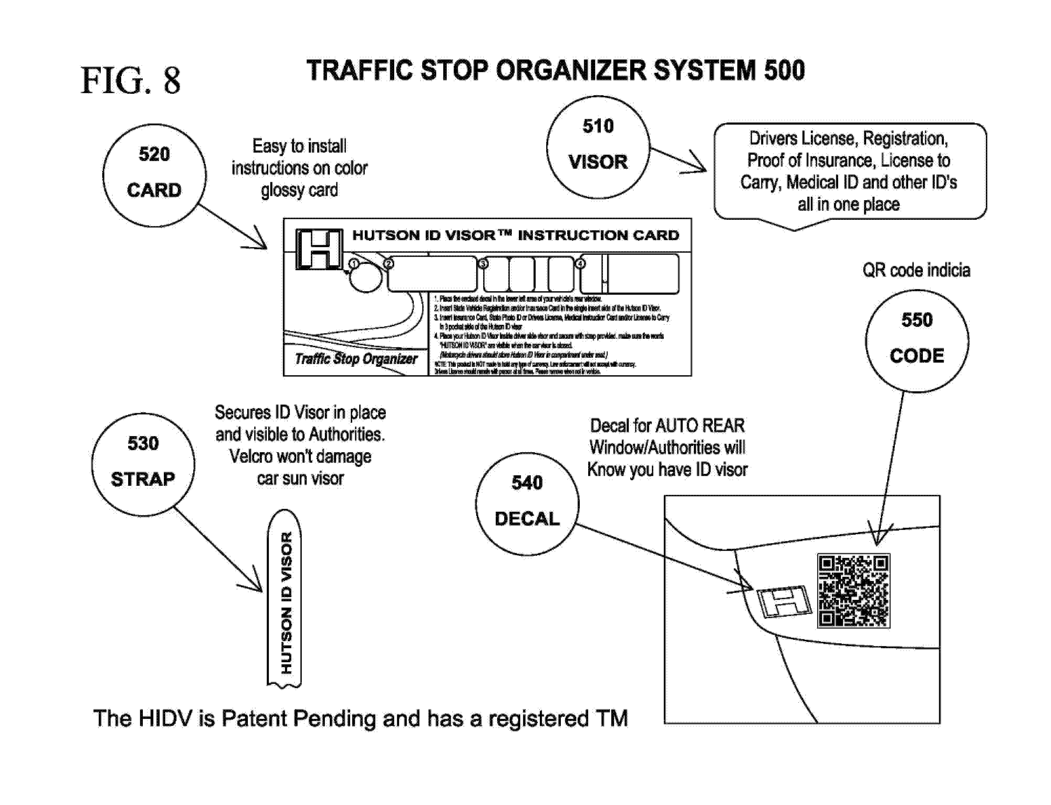

FIG. 8 is a schematic representation of elements that may be included in one or more embodiments of a vehicle documentation organizer system in addition to the clip 400 described above.

FIG. 8 indicates the vehicle documentation organizer system 500 can include an organizer/visor 510, an instruction card 520 (abbreviated in FIG. 8 as a “card”), a mounting element/strap 530, a decal 540, and a 550 code (shown in FIG. 8 as a QR code). The organizer/visor 510 can be manufacturer similar to the organizer/visor 10 shown in FIGS. 2-5. Accordingly the organizer/visor 510 incorporates multiple compartments for holding traffic stop documentation, including, but not limited to a driver's license, vehicle registration, proof of insurance, medical identification cards, and other types of identification. The instruction card 520 includes card indicia such as words, photographs, etc., used to instruct a user of the system on the proper way to install the system 500 with respect to automobile and traffic stop use. The mounting element/strap 520 is preferably manufactured from a resilient fabric material that is capable of securing the organizer/visor 510 to a separate visor or other automobile component such that the organizer/visor 510 is visible to law enforcement during a traffic stop. The strap 520 also preferably include hook and loop fasteners such as those sold under the mark VELCRO. The overall system 500 also preferably includes a decal 540 or other indicia that is attachable to the exterior of a vehicle via adhesives or some other method of attachment. The decal 540 serves to alert law enforcement personnel that the driver of the vehicle is associated with a vehicle documentation organizer system 500. Near, attached to or incorporated with the decal is a code 550 such as a QR code or barcode that associates the decal with the identification of the driver. Upon scanning of the code 550 a law enforcement office may, for example, be directed to an online database where users of the system 500 are registered. All of the aforementioned elements of the system may also be incorporated into a kit, including an organizer/visor 510, an instruction card 520, a mounting element/strap 530, a decal 540, a code 550, and packaging that holds all of the system's elements.

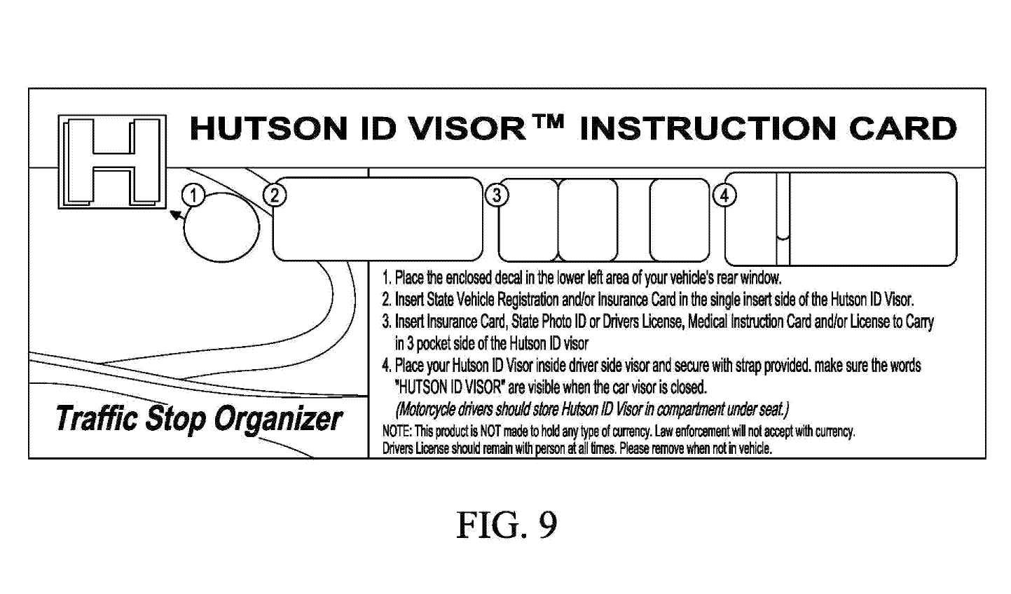

FIG. 9 shows an enlarged view of an exemplary instruction card 520 that may be included in one or more embodiments of a vehicle documentation organizer system 500.

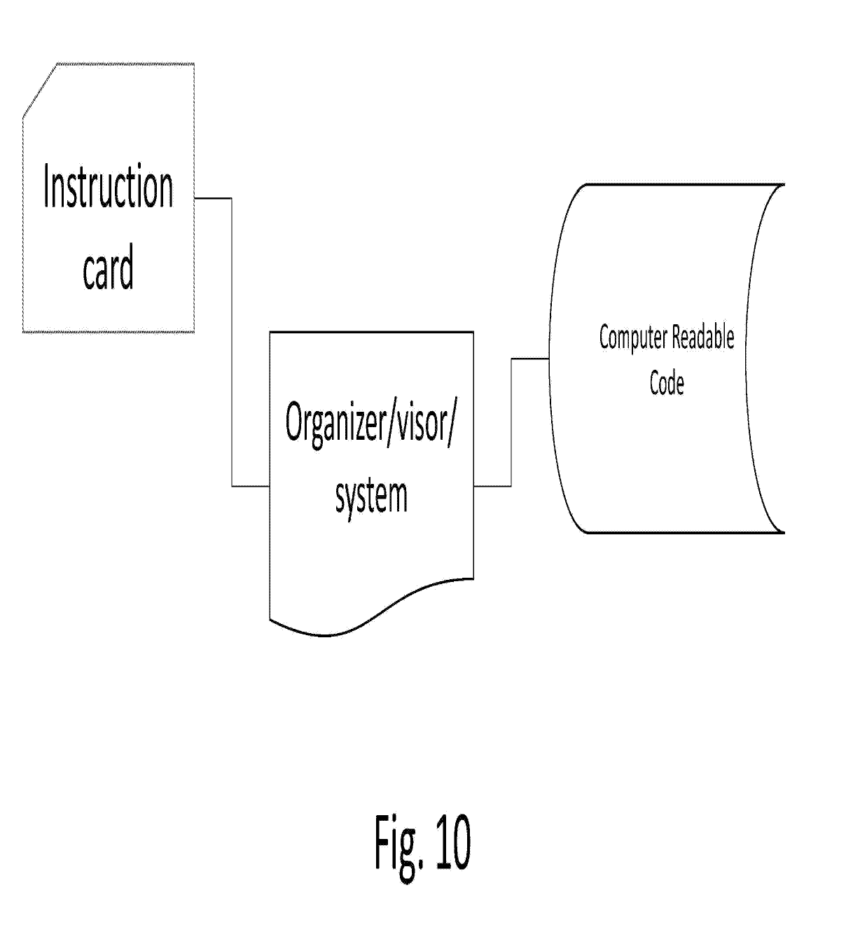

FIG. 10 shows a flowchart of an exemplary vehicle documentation organizer system and method, which includes a mobile device/computer application.

The vehicle documentation organizer system includes a mobile application (e.g. for use on a computer, smartphone, or tablet) capable of connection to a computerized device such as a mobile device (i.e. mobile phone, tablet, handheld device) and/or a computer. The mobile application, via the computerized device, is configured to transmit and receive information from various databases that are accessible to various types of personnel. Such personnel includes those persons associated with various types of entities, including, but not limited to law enforcement, fire prevention, medical, travel and vehicle services (e.g. towing companies, AAA, travel agencies, etc.) and emergency services. The system can include various types of element disclosed in patent applications, describing mobile applications. For example, the methods and systems disclosed in U.S. patent application Ser. No. 13/299,127, titled, “Linked Methods and Systems,” invented by Tony F. Rodriguez, and U.S. patent application Ser. No. 10/081,257, titled, Virtual document organizer system and method, invented by Jeffrey Mankoff each of which is incorporated herein by reference in its entirety.

The application can further be configured to provide motor vehicle assistance via tools that are integrated to the application and accessible via the computerized device. Such tools, for example, include access to insurance policies and claim information, digital Identification (ID) cards and accident support, among other types of services.

The application can further be configured to include various types of media, in the form of images and video, for example.

The method of the vehicle documentation organizer system includes the steps of:
providing a user interface via a mobile application, transmitting data received from QR code database and/or the user interface to the mobile application; transferring the transmitted data to personnel for purposes of identification.

As will be understood by one skilled in the art, for any and all purposes, such as in terms of providing a written description, all ranges disclosed in this disclosure also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed in this disclosure can be readily broken down into a lower third, middle third and upper third, etc. Finally, as will be understood by one skilled in the art, a range includes each individual member.

From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

1. A vehicle documentation system, comprising:
an instruction card, having indicia disposed thereon;
a vehicle documentation organizer/visor, including one or more compartments for insertion of documentation and the instruction card wherein the vehicle documentation organizer/visor, comprises
a base layer having a first surface and a second surface opposite the first surface;
a first document layer connected to the base layer and mounted to the first surface along edges of the base layer, having an opening such that an elongated compartment is formed in the organizer/visor for insertion of an elongated traffic stop document; and
a plurality of second document layers connected to the base layer and mounted to the first surface along edges of the base layer, having a plurality of openings such that shortened compartments are formed in the organizer/visor for insertion of a shortened traffic stop document; and
a code, disposed the vehicle documentation organizer/visor, the code including a portion attachable to a vehicle, wherein the code is scannable and associated with a database.

2. The vehicle documentation system of claim 1, further comprising a mounting element/strap.

3. The vehicle documentation system of claim 1, further comprising a decal attachable to the exterior of a vehicle.

4. The vehicle documentation system of claim 2, wherein the mounting element/strap comprises a fabric-based material mountable to the vehicle documentation organizer/visor.

5. The vehicle documentation system of claim 1, wherein the database is associated with a mobile application contained within a computerized device.

6. The vehicle documentation system of claim 5, wherein the mobile application includes a user interface for entering in identifying information.

7. The vehicle documentation system of claim 1, wherein the mobile application is configured to transmit information entered in the user interface to a database.

8.-9. (canceled)
